(19) United States
(12) Patent Application Publication
(10) Pub. No.: US 2021/0400481 A1
(43) Pub. Date: Dec. 23, 2021

(54) SERVICE PROVISION SYSTEM AND SERVICE PROVISION METHOD

(71) Applicant: KABUSHIKI KAISHA TOKAI RIKA DENKI SEISAKUSHO, Aichi (JP)

(72) Inventors: Kenji NARUMI, Aichi (JP); Satoshi ARIKURA, Aichi (JP); Yuki MORI, Aichi (JP); Masahiko OYA, Aichi (JP); Masahiro ARAKAWA, Aichi (JP)

(73) Assignee: KABUSHIKI KAISHA TOKAI RIKA DENKI SEISAKUSHO, Aichi (JP)

(21) Appl. No.: 17/418,455

(22) PCT Filed: Dec. 20, 2019
(86) PCT No.: PCT/JP2019/050123

§ 371 Date: Jun. 25, 2021

(30) Foreign Application Priority Data
Dec. 27, 2018 (JP) 2018-245257

(51) Int. Cl. H04W 12/06; H04W 12/0431; H04W 4/80

(52) U.S. Cl. CPC H04W 12/06; H04W 4/80; H04W 12/0431

(57) ABSTRACT

When a request for the maintenance of a vehicle is received from a user, a second delivery unit delivers, to a service provider terminal, second key information that is different from first key information delivered to a user terminal. The service provider is able to drive the vehicle using the service provider terminal to which the second key information has been delivered. The service provider drives the vehicle and brings the vehicle to a garage, and then executes a maintenance operation. After maintenance is completed, the service provider drives the vehicle and returns the vehicle to the former parking position.

### TECHNICAL FIELD

The present disclosure relates to a service provision system and a service provision method for providing a service related to an operation target for a user.

### BACKGROUND ART

A vehicle receives a regular car maintenance service at the time of vehicle inspections and breakdowns, for example. In general, in this type of car maintenance service, a user goes to a store such as a dealer, passes the vehicle and a key to a service provider, and receives maintenance of the vehicle. After the maintenance operation, the user gets back the vehicle and the key and goes back. JP-A-2015-210638 discloses a technique for managing a process of a car maintenance operation on a computer to improve efficiency.

### SUMMARY OF INVENTION

In the case of a method in which a user itself goes to a store such as a dealer to receive maintenance, it is necessary for the user to drive the vehicle to the store such as a dealer by itself at the convenience of time. In addition, even if the maintenance operation is managed by a computer to improve work efficiency, there is a limit in shortening the work time during busy times such as holidays, and a waiting time of the user tends to be long.

Therefore, it is required to reduce the annoyance felt by the user at the time of receiving the service.

One aspect for responding to the above request is a service provision system in which an operation of an operation target is allowed when authentication is established via short-range wireless communication between an authentication device connected to the operation target and a mobile terminal having acquired key information required for the authentication, the service provision system including:

a first delivery unit configured to deliver first key information as the key information to a mobile terminal carried by a user of the operation target; and

a second delivery unit configured to deliver, when the user receives a service from a service provider that provides the service specified to the operation target, second key information including different information from the first key information as the key information to a mobile terminal carried by the service provider.

One aspect for responding to the above request is a service provision method in which an operation of an operation target is allowed when authentication is established via short-range wireless communication between an authentication device connected to the operation target and a mobile terminal having acquired key information required for the authentication, the service provision method including:

a step of delivering first key information as the key information to the mobile terminal carried by a user of the operation target; and

a step of delivering, when the user receives a service from a service provider that provides the service specified to the operation target, second key information including different information from the first key information as the key information to a mobile terminal carried by the service provider.

According to the configuration of each aspect described above, when the user receives the provision of the specified service, the key information different from the key information delivered to the mobile terminal carried by the user is delivered to the mobile terminal carried by the service provider. As a result, the operation target can be also operated by the mobile terminal carried by the service provider. Since the user can save the trouble of bringing the operation target to the store or the like, it is possible to reduce the annoyance felt by the user at the time of receiving the service.

### BRIEF DESCRIPTION OF DRAWINGS

FIG. 1 illustrates a configuration of an electronic key system and an authentication system according to an embodiment.

FIG. 2 illustrates a flow for authentication of key information registered in a mobile terminal.

FIG. 3 illustrates a flow when operating a vehicle with the mobile terminal.

FIG. 4 illustrates a configuration of a service provision system.

FIG. 5 illustrates a flow of an on-site car maintenance service.

FIG. 6 illustrates continuation of the flow shown in FIG. 5.

FIG. 7 illustrates a procedure from making a request for key information issuance on a user terminal to locking a vehicle door.

FIG. 8 illustrates another procedure from making a request for key information issuance on a user terminal to locking a vehicle door.

### DESCRIPTION OF EMBODIMENTS

A service provision system and a service provision method according to an embodiment will be described in detail below with reference to the accompanying drawings.

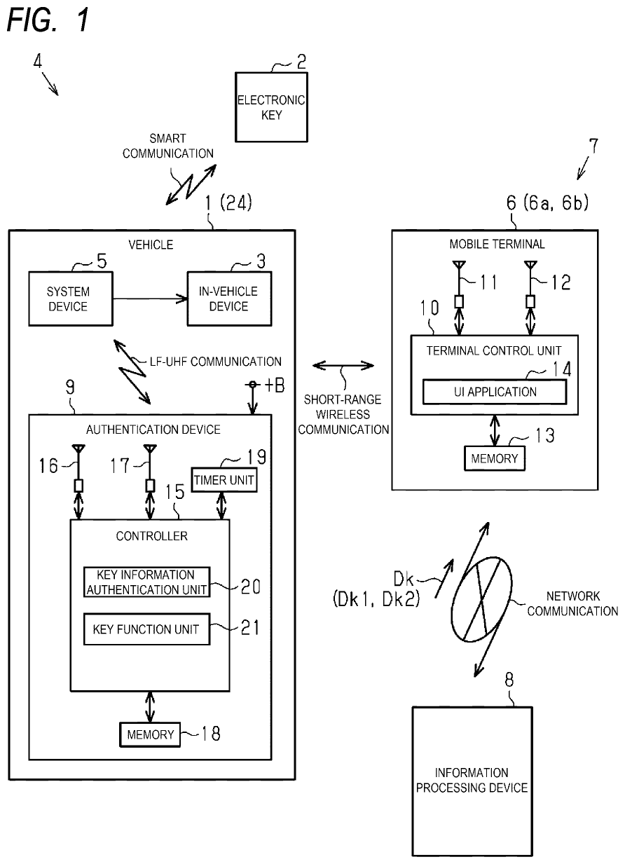

As illustrated in FIG. 1, a vehicle 1 includes an electronic key system 4 that permits or executes an operation of an in-vehicle device 3 through wireless ID collation with an electronic key 2. It is preferable that the electronic key system 4 is a smart collation system that performs ID collation (smart collation) by narrow-band radio in the wake of communication from the vehicle 1. The in-vehicle device 3 includes, for example, a door lock device that opens and closes a vehicle door, an engine of the vehicle 1, and the like.

The electronic key system 4 includes a system device 5 that operates the electronic key system 4 in the vehicle 1. An electronic key ID and a key unique key to be used in the smart collation are registered in the electronic key 2 and the system device 5. The electronic key 2 and the system device 5 perform smart collation through bidirectional communication in which communication is executed by transmitting and receiving radio waves to and from each other. The smart collation executes, for example, electronic key ID collation for confirming whether or not an electronic key ID is correct, challenge response authentication using a key unique key, or the like. Radio waves in the low frequency (LF) band are used for radio wave transmission from the system device 5 to the electronic key 2, and radio waves in the ultra high frequency (UHF) band are used for radio wave transmission from the electronic key 2 to the system device 5.

When smart communication (outdoor smart communication) is executed with the electronic key 2 located outdoors, the system device 5 permits or executes locking and unlocking of a vehicle door if smart collation (outdoor smart collation) is established. As a result, the vehicle door is unlocked when a vehicle outside door handle is touch-operated, and the vehicle door is locked when a lock button on vehicle outside door handle is operated. When smart communication (indoor smart communication) is executed with the electronic key 2 located indoors, the system device 5 permits a transition operation of a vehicle power supply if smart collation (indoor smart collation) is established. As a result, when an engine switch in a driver seat is pressed while depressing a brake pedal, the engine starts.

The vehicle 1 includes a wireless authentication function (authentication system 7) that permits or executes an operation of the in-vehicle device 3 via the authentication through the short-range wireless communication with the mobile terminal 6 in which key information Dk is registered via the network communication. The authentication system 7 registers, for example, encrypted key information Dk from the outside (information processing device 8 in the present embodiment) to the mobile terminal 6. The authentication system 7 authenticates the key information Dk through short-range wireless communication with an authentication device 9 mounted on the vehicle 1, and sets the authentication result as one condition of the operability of the vehicle 1. The mobile terminal 6 is preferably, for example, a high-performance mobile phone.

The information processing device 8 includes a first delivery unit 22 that delivers first key information (hereinafter, referred to as first key information Dk1), which is one of the key information Dk, to the mobile terminal 6 (hereinafter, referred to as a user terminal 6a) carried by a user of the vehicle 1. When the first delivery unit 22 receives a request for delivery of the first key information Dk1 from the user terminal 6a, the first delivery unit 22 delivers the first key information Dk1 to the user terminal 6a via the network communication.

When the key information Dk is given to the user terminal 6a used by an owner of the vehicle 1, it is preferable that the key information Dk is the first key information Dk1 positioned as an owner key that does not include restrictions on the operation of the vehicle 1. When the key information Dk is given to a mobile terminal 6 (hereinafter, referred to as a service provider terminal 6b) used by another person who is not the owner of the vehicle 1 (a service provider, a family member or the like), it is preferable that the key information Dk is key information positioned as a one-time key (one-time password) that includes restrictions on the operation of the vehicle 1 as different information (hereinafter, referred to as second key information Dk2). In the present embodiment, the different information is information that is permitted to be used only once, and includes an element of usage time restriction.

The mobile terminal 6 includes a terminal control unit 10 that controls the operation of the mobile terminal 6, a network communication module 11 that performs network communication in the mobile terminal 6, a short-range wireless module 12 that performs the short-range wireless communication in the mobile terminal 6, and a memory 13 in which data can be written and rewritten. When the key information Dk is acquired from the information processing device 8 through the network communication, the mobile terminal 6 writes and stores the key information Dk in the memory 13. The short-range wireless communication is preferably, for example, Bluetooth (registered trademark).

The mobile terminal 6 includes a user interface application 14 that manages the operation of the authentication system 7 in the mobile terminal 6. The user interface application 14 is, for example, downloaded from the information processing device 8 and registered in the terminal control unit 10. The user interface application 14 executes various processes such as a procedure of using the vehicle by the mobile terminal 6 (a setting procedure for allowing the mobile terminal 6 to operate the vehicle), an operation of locking and unlocking the vehicle door, an operation of starting the engine of the vehicle 1, and the like.

The authentication device 9 includes a controller 15 that controls the operation of the authentication device 9, a smart communication block 16 that performs smart communication in the authentication device 9, a short-range wireless module 17 that performs short-range wireless communication in the authentication device 9, a memory 18 in which data can be written and rewritten, and a timer unit 19 that manages date and time in the authentication device 9. The authentication device 9 has a one-to-one relationship with the vehicle 1 by associating an authentication device ID registered therein with, for example, a vehicle body ID (vehicle body number) of the vehicle 1. The timer unit 19 includes, for example, a software timer.

The authentication device 9 includes a key information authentication unit 20 that authenticates whether or not the key information Dk registered in the mobile terminal 6 is correct, and a key function unit 21 that operates the authentication device 9 like the electronic key 2. The key information authentication unit 20 and the key function unit 21 are provided in the controller 15. The key information authentication unit 20 acquires the key information Dk from the mobile terminal 6 through short-range wireless communication, and authenticates the key information Dk. When the authentication of the key information Dk is established, the key information authentication unit 20 switches the key function unit 21 to an ON state (enabled). When the key function unit 21 is switched to the ON state, it becomes possible to execute communication (wireless communication or smart communication) with the system device 5 through the electronic key system 4.

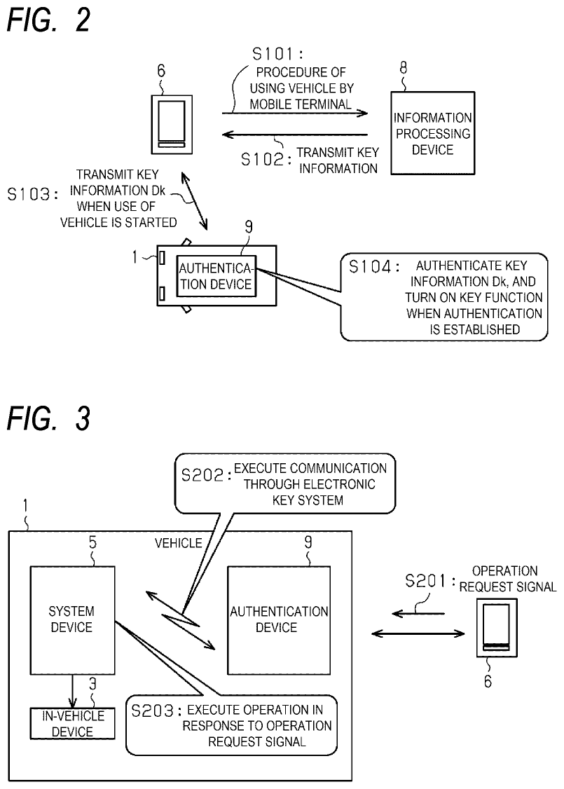

As illustrated in FIG. 2, when the vehicle 1 is operated by the mobile terminal 6, the key information Dk is registered in the mobile terminal 6, and the key information Dk is authenticated between the vehicle 1 and the mobile terminal 6. In this case, first, in step S101, the mobile terminal 6 executes the procedure of using the vehicle by the mobile terminal 6 with the information processing device 8 through network communication. This procedure is, for example, authentication for confirming a user ID and a password given at the time of use registration of the authentication system 7.

In step S102, when the procedure of using the vehicle by the mobile terminal 6 is completed, the first delivery unit 22 of the information processing device 8 generates the key information Dk (here, the first key information Dk1), and transmits the generated key information Dk to the mobile terminal 6 through the network communication. At this time, the first delivery unit 22 generates the first key information Dk1 using the information acquired during the procedure of using the vehicle by the mobile terminal 6. When the first key information Dk1 is delivered to the user terminal 6a, the first key information Dk1 includes encryption information generated by using, for example, “permanent usage notification”, “terminal ID (ID of the user terminal 6a)”, “user authentication key” and the like as the original information and a cryptographic key of the authentication device 9 (for example, the unique key of the authentication device) provided on the vehicle 1 as an encryption key, and substituting these into an encryption expression (encryption algorithm). The permanent usage notification is a notification indicating that the key information Dk can be used without any time or period limitation. The user authentication key is, for example, a key used in cryptographic communication between the mobile terminal 6 and the authentication device 9 when an operation is performed on the vehicle by the mobile terminal 6. When receiving the key information Dk from the information processing device 8, the mobile terminal 6 writes and stores the key information Dk in the memory 13.

In step S103, when the short-range wireless communication with the vehicle 1 is established, the mobile terminal 6 transmits the key information Dk registered in the mobile terminal 6 itself through the short-range wireless communication. The key information Dk is transmitted to the authentication device 9 through, for example, Bluetooth Low Energy (BLE).

In step S104, when the authentication device 9 receives the key information Dk from the mobile terminal 6, the authentication device 9 authenticates the key information Dk. In the present embodiment, the key information authentication unit 20 decrypts the key information Dk using the cryptographic key (for example, the unique key of the authentication device), and confirms whether or not the decryption is successful. In a case of the first key information Dk1, when the decryption of the first key information Dk1 is successful, it is possible to acquire the original information such as the “permanent usage notification”, the “terminal ID”, and the “user authentication key” included in the first key information Dk1. As a result, the owner of the vehicle 1 can operate the vehicle 1 with the mobile terminal 6 thereof.

When the authentication of the key information Dk is successful, the authentication device 9 shifts to an “authentication completed state” of the key information Dk, and the key function unit 21 is turned on (the smart function is enabled). Therefore, the key function unit 21 can perform various types of communication (wireless communication or smart communication) through the electronic key system 4. When the authentication of the key information Dk is successful, the authentication device 9 writes and stores the key information Dk and the user authentication key in the memory 18. In wireless communication or smart communication, collation of the authentication device ID is executed.

When the authentication of the key information Dk is successful, the authentication device 9 notifies the mobile terminal 6 of the user authentication key acquired in the authentication through the short-range wireless communication. When receiving the user authentication key from the authentication device 9, the mobile terminal 6 registers the user authentication key in the memory 13. As described above, the user authentication key is registered in both the mobile terminal 6 and the authentication device 9. Therefore, when the vehicle 1 is operated by the mobile terminal 6 through the authentication device 9, the user authentication key is used for the cryptographic communication between the mobile terminal 6 and the authentication device 9. The user authentication key is preferably updated to a new key each time short-range wireless communication between the mobile terminal 6 and the authentication device 9 is established.

As illustrated in FIG. 3, in a case where the vehicle 1 is operated by the mobile terminal 6 in which the key information Dk is registered, in Step S201, when an operation request button (a display button on the screen) of the mobile terminal 6 is operated in the authentication completed state, the mobile terminal 6 transmits an operation request signal corresponding to the button to the authentication device 9 via short-range wireless communication. The operation request button includes, for example, an unlocking request button operated when the vehicle door is to be unlocked, a locking request button operated when the vehicle door is to be locked, an engine start request button operated when the vehicle 1 is allowed to start the engine, and the like. The operation request signal is a signal including a command corresponding to the operated operation request button. The operation request signal is encrypted and transmitted by, for example, a user authentication key.

In step S202, when the key function unit 21 receives the operation request signal from the mobile terminal 6 in the ON state, the key function unit 21 executes communication (wireless communication or smart communication) through the electronic key system 4, and notifies the system device 5 of the operation request signal in the process of the communication. In the present embodiment, for example, in the case of the operation of locking and unlocking the vehicle door, a door locking signal or a door unlocking signal is wirelessly transmitted from the key function unit 21. In addition, in the case of an engine start operation, smart collation is executed between the system device 5 and the key function unit 21, and it is confirmed whether or not smart collation is established.

In step S203, the system device 5 executes an operation in response to the operation request signal notified from the authentication device 9 through communication (wireless communication or smart communication) with the authentication device 9 (the key function unit 21). As a result, locking and unlocking of the vehicle door, permission of the engine start operation, and the like are executed.

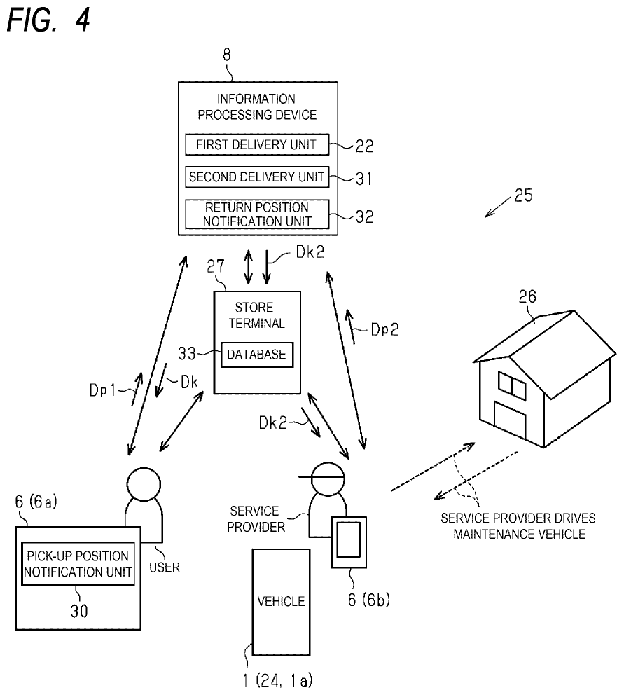

As illustrated in FIG. 4, a service provided by the service provision system 25 using the delivery of the key information Dk is provided to the vehicle 1, which is an example of an operation target 24 of the mobile terminal 6. In the present embodiment, the service provision system 25 is, for example, an on-site car maintenance service in which a service provider for car maintenance comes to pick up a vehicle of a user (hereinafter, referred to as a maintenance vehicle 1a), performs maintenance in a garage 26, and returns the vehicle to the user after the maintenance. The service provider provides services defined for the vehicle 1, which is the operation target 24. In the present embodiment, the service provision system 25 delivers the key information Dk (in the present embodiment, the second key information Dk2 different from the first key information Dk1) of the maintenance vehicle 1a to the mobile terminal 6 of the service provider (service provider terminal 6b).

The service provision system 25 includes a store terminal 27 that manages a service in a store to which the service provider belongs. The store terminal 27 can perform network communication with the user terminal 6a, the service provider terminal 6b, the information processing device 8, and the like. The store terminal 27 is installed in, for example, a store or the like operated by a service provider. The service provider is an entity that operates the car maintenance service. The store terminal 27 may be either a desktop type or a mobile type.

The service provision system 25 includes a pick-up position notification unit 30 that notifies the service provider of a position where the vehicle 1 is to be picked up when receiving the service of the service provision system 25. The pick-up position notification unit 30 is provided in the user terminal 6a (the terminal control unit 10). When receiving the on-site car maintenance service, the pick-up position notification unit 30 notifies, from the user, the service provider of position information Dp1 on a place where the service provider comes to pick up the maintenance vehicle 1a.

The service provision system 25 includes a second delivery unit 31 that delivers key information Dk that enables the service provider to use the vehicle 1. The second delivery unit 31 is provided in the information processing device 8. In the present embodiment, when receiving the service by the service provider (the on-site car maintenance service), the second delivery unit 31 delivers, to the service provider terminal 6b used by the service provider, the second key information Dk2, which is one of the key information Dk and includes information different from the first key information Dk1. It is preferable that the second key information Dk2 is once sent from the information processing device 8 to the store terminal 27 and then delivered from the store terminal 27 to the service provider terminal 6b. The second key information Dk2 is preferably a one-time key (one-time password) in which use of the vehicle 1 is restricted.

The service provision system 25 includes a return position notification unit 32 that notifies the user of a return position of the vehicle 1 for which the service is completed. The return position notification unit 32 is provided in the information processing device 8. After the vehicle maintenance service is completed, the return position notification unit 32 notifies, from the service provider, the user of a vehicle position notification notifying a place where the maintenance vehicle 1a is to be returned to the user. In the present embodiment, the return position notification unit 32 transmits the vehicle position notification of the maintenance vehicle 1a via, for example, the store terminal 27.

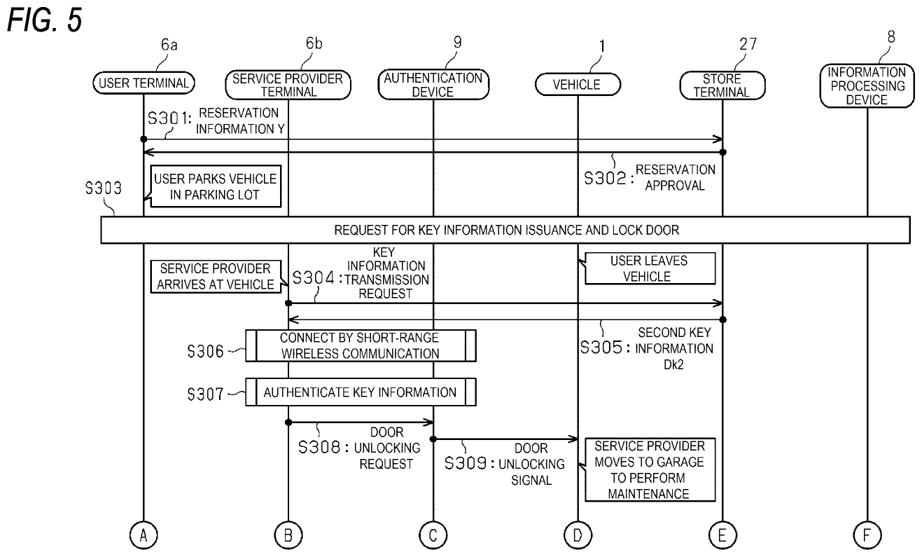

Next, operations and effects of the service provision system 25 according to the present embodiment will be described with reference to FIGS. 5 to 8.

As illustrated in FIG. 5, in step S301, the user terminal 6a transmits reservation information Y to the store terminal 27 via the network when a reservation operation for vehicle maintenance is performed on the user terminal 6a as “advance reservation”. The reservation information Y includes a maintenance content, a pick-up time, a pick-up location, and the like of the vehicle 1. The pick-up time of the vehicle 1 is a start time that depends on a request for maintenance of the vehicle 1. The pick-up location is a location where the service provider comes to pick up the maintenance vehicle 1a.

In step S302, when the reservation information Y received from the user terminal 6a is approved, the store terminal 27 transmits a reservation approval to the user terminal 6a via the network. On the day of maintenance, the user parks the maintenance vehicle 1a in a parking lot designated by the pick-up position, for example. At this time, as the parking lot where the maintenance vehicle 1a is parked, a parking lot at work, a parking lot at outside and the like can be exemplified.

In step S303, a series of devices executes each process of request for key information issuance and locking the door.

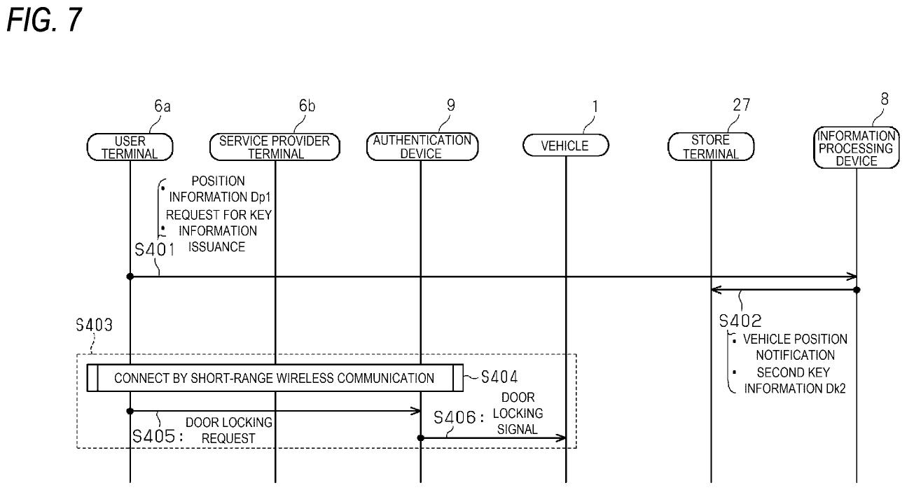

FIG. 7 illustrates an example of the processes of request for key information issuance and locking the door. In step S401, when the user terminal 6a receives, for example, a maintenance start operation on the terminal, the user terminal 6a transmits the position information Dp1 and the request for key information issuance to the information processing device 8 through the network communication. At this time, the pick-up position notification unit 30 acquires and transmits the position information Dp1. The position information Dp1 is a place where the maintenance vehicle 1a is parked. A method of acquiring the position information Dp1 may be any one of, for example, a method of acquiring from a Global Positioning System (GPS) provided in the user terminal 6a, a method of acquiring from a GPS provided in the authentication device 9, and a method of acquiring from a GPS provided in the vehicle 1 (a car navigation system or the like). The request for key information issuance is a request to register the second key information Dk2, which is another piece of key information, in the service provider terminal 6b.

In step S402, when receiving the position information Dp1 and the request for key information issuance from the user terminal 6a, the information processing device 8 transmits the vehicle position notification for notifying a vehicle position which is obtained from the position information Dp1 and the second key information Dk2 generated by the information processing device 8 to the store terminal 27 via the network. The second key information Dk2 is generated by the second delivery unit 31 of the information processing device 8. At this time, in the present embodiment, the second delivery unit 31 generates the second key information Dk2 having a content different from that of the first key information Dk1 given to the user terminal 6a, and transmits the second key information Dk2 to the store terminal 27 via the network.

The second key information Dk2 includes information obtained by encrypting a data group based on the content of the reservation information Y of the user. In the present embodiment, the second key information Dk2 includes, encryption information generated by using, for example, “reservation time”, “terminal ID (ID of the service provider terminal 6b)”, “user authentication key” and the like as the original information and a cryptographic key of the authentication device 9 (for example, the unique key of the authentication device) provided on the vehicle 1 as an encryption key, and substituting these into an encryption expression (encryption algorithm). The reservation time is a time zone for requesting vehicle maintenance. The vehicle position notification (position information Dp1) acquired from the information processing device 8 and the second key information Dk2 generated by the information processing device 8 are managed by the store terminal 27. In the store, the second key information Dk2 delivered from the information processing device 8 and the user (maintenance vehicle 1a) are associated with each other and managed in a database 33 of the store terminal 27.

In step S403, the authentication device 9 of the maintenance vehicle 1a and the user terminal 6a execute an operation for leaving an original key of the maintenance vehicle 1a, that is, the electronic key 2 in the vehicle. That is, at the time of getting out of the vehicle, the user is required to leave the electronic key 2 in a specified place (for example, a dashboard or the like in the vehicle) in the vehicle, and after the electronic key 2 is left in the vehicle, the vehicle door is locked. This is because the operation of starting the vehicle engine by the mobile terminal 6 such as a high-performance mobile phone is not permitted by regulations. Therefore, if the regulations are revised in the future, the process of step S403 may be omitted.

As a specific operation of step S403, first, in step S404, the authentication device 9 of the maintenance vehicle 1a and the user terminal 6a establish short-range wireless communication (Bluetooth communication) when the user terminal 6a approaches the maintenance vehicle 1a. For example, when the user terminal 6a receives an advertisement periodically transmitted from the authentication device 9 of the maintenance vehicle 1a, device authentication (authentication of an ID, a password, or the like) is performed therebetween. When the device authentication is established, the user terminal 6a is shifted to a state in which short-range wireless communication is established.

In step S405, after the short-range wireless communication is established, when the user terminal 6a performs a door locking operation, the user terminal 6a transmits a door locking request to the authentication device 9 of the maintenance vehicle 1a through the short-range wireless communication. The door locking operation includes, for example, an operation of touching a door locking button displayed on a screen of the user terminal 6a.

In step S406, when the authentication device 9 of the maintenance vehicle 1a receives the door locking request from the user terminal 6a, the authentication device 9 transmits a door locking signal for requesting the system device 5 of the maintenance vehicle 1a to execute the door operation to the system device 5 of the maintenance vehicle 1a through the electronic key system 4. The door locking signal includes a command for requesting the vehicle 1 to lock the vehicle door and the authentication device ID. The door locking signal is transmitted to the system device 5 of the maintenance vehicle 1a by UHF radio waves. When the system device 5 of the maintenance vehicle 1a receives the door locking signal from the authentication device 9 of the maintenance vehicle 1a, the system device 5 locks the vehicle door by using the door locking signal as a trigger. After the maintenance vehicle 1a is shifted to a parking state, the user leaves the maintenance vehicle 1a.

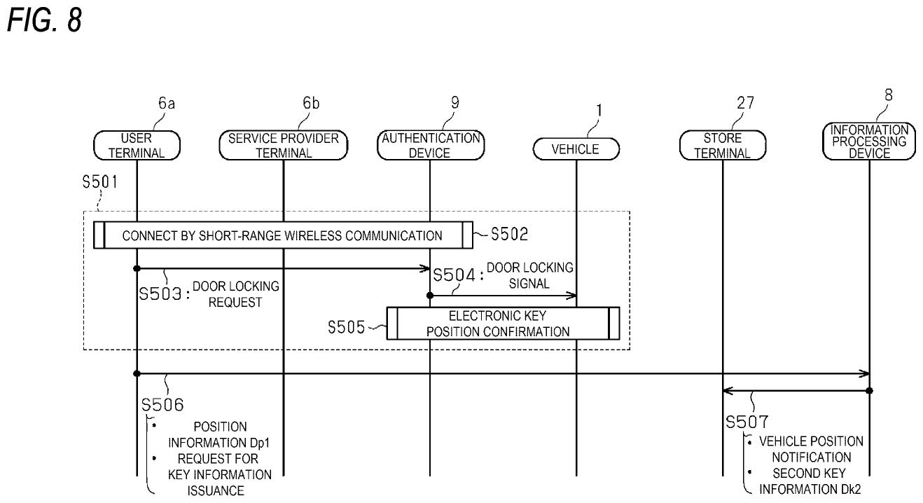

FIG. 8 illustrates another example of the processes of request for key information issuance and locking the door. The present embodiment is a specific plan for not forgetting to leave the electronic key 2 in the vehicle when the maintenance vehicle 1a is handed over to the service provider.

In step S501, the authentication device 9 of the maintenance vehicle 1a and the user terminal 6a execute an operation for leaving the electronic key 2, which is the original key, in the vehicle as in step S403 described above. In this case, if the regulations are revised in the future, the process of step S501 may also be omitted. Steps S502 to S504, which are a part of the processing of step S501, are the same as steps S404 to S406 described above, and thus the description thereof will be omitted.

In step S505, the authentication device 9 of the maintenance vehicle 1a and the vehicle 1 (the system device 5) execute the electronic key position confirmation for confirming that the electronic key 2 is positioned in the vehicle. In the present embodiment, the electronic key position confirmation is preferably a process of confirming whether or not an indoor smart collation is established. In a case where the electronic key 2 is left in the vehicle, it is preferable that the operation is invalidated by, for example, an input operation of invalidating the electronic key 2. The input operation of invalidating the electronic key 2 includes, for example, an operation of accepting via a dedicated mechanical switch, an operation of accepting via the user terminal 6a, an operation of accepting via various switches arranged in the vehicle 1, and the like. It should be noted that even if the electronic key 2 is invalidated due to the input operation, smart communication can be performed.

In the present embodiment, when the authentication device 9 receives the door locking request from the user terminal 6a, the authentication device 9 causes the system device 5 to execute the indoor smart collation. When the electronic key 2 is left in the vehicle, the indoor smart collation is established. In the present embodiment, only when it is confirmed that the electronic key 2 is left in the vehicle, the user terminal 6a is permitted to transmit the position information Dp1 and the like to the information processing device 8.

In addition, the electronic key position confirmation may be, for example, a determination to confirm the intensity of a signal received from the electronic key 2. In this case, when the intensity of the signal received from the electronic key 2 exceeds a threshold value, it is determined that the electronic key 2 is left in the vehicle.

On the other hand, when the electronic key 2 is forgotten to be left in the vehicle, the indoor smart collation is not established. In a case where the indoor smart collation is not established in the electronic key position confirmation, a process of notifying the user of the fact is executed. Examples of this process include displaying the fact on the screen of the user terminal 6a, outputting an error message from the user terminal 6a and the like.

In addition, the authentication device 9 may determine whether or not the electronic key 2 is forgotten to be left in the vehicle when the door is locked. A condition for determining that the electronic key 2 is forgotten to be left in the vehicle is, for example, at least a case where an input operation for invalidating the electronic key 2 is not received. As a condition for determining that the electronic key 2 is forgotten to be left in the vehicle, at least the intensity of a signal received from the electronic key 2 may exceed a threshold value when the input operation for invalidating the electronic key 2 is not received.

In the case where the electronic key position confirmation is established, in steps S506 and S507, the same processes as those in steps S401 and S402 described above are executed, and the vehicle position notification and the second key information Dk2 are delivered to the store terminal 27.

As illustrated in FIG. 5, in step S304, when the service provider performs a key information request operation on the terminal when the service provider arrives at the maintenance vehicle 1a, the service provider terminal 6b transmits a key information transmission request to the store terminal 27 via the network. It is preferable that the key information request operation is, for example, an operation of inputting various types of information of the maintenance vehicle 1a (license plate, vehicle type, and the like) to the service provider terminal 6b and requesting delivery of the second key information Dk2 for the maintenance vehicle 1a. As described above, in the key information transmission request, it is notified which maintenance vehicle 1a is requested to deliver the second key information Dk2.

In step S305, when receiving the key information transmission request (for the maintenance vehicle 1a) from the service provider terminal 6b, the store terminal 27 checks the database 33 to determine the second key information Dk2 required to operate the maintenance vehicle 1a for which the notification is requested, and transmits the second key information Dk2 to the service provider terminal 6b via the network. When receiving the second key information Dk2 transmitted from the store terminal 27, the service provider terminal 6b writes and stores the second key information Dk2 in the memory 13. Therefore, the second key information Dk2 required to operate the maintenance vehicle 1a is registered in the service provider terminal 6b.

In step S306, when the service provider approaches to get on the maintenance vehicle 1a, the service provider terminal 6b is shifted to a state in which short-range wireless communication is established with the authentication device 9 of the maintenance vehicle 1a.

In step S307, the service provider terminal 6b and the authentication device 9 of the maintenance vehicle 1a execute authentication of the second key information Dk2 registered in the service provider terminal 6b under the state where the short-range wireless communication is established. Since the authentication of the second key information Dk2 is the same as that of step S104, the description thereof is omitted. When the second key information Dk2 is correctly decrypted, a user authentication key and the like used for encryption at the time of short-range wireless communication with the authentication device 9 of the maintenance vehicle 1a can be acquired.

In step S308, when a door unlocking operation is executed on the terminal under the authentication of the second key information Dk2, the service provider terminal 6b transmits a door unlocking request to the authentication device 9 of the maintenance vehicle 1a through the short-range wireless communication. The door unlocking operation includes, for example, an operation of touching a door unlocking button displayed on a screen of the service provider terminal 6b.

In step S309, when receiving the door unlocking request from the service provider terminal 6b, the authentication device 9 of the maintenance vehicle 1a transmits the door unlocking signal to the system device 5 of the maintenance vehicle 1a by UHF through the electronic key system 4. When the system device 5 of the maintenance vehicle 1a receives the door unlocking signal from the authentication device 9 of the maintenance vehicle 1a, the system device 5 unlocks the vehicle door by using the door unlocking signal as a trigger. After unlocking the vehicle door, the service provider starts the engine using the electronic key 2 in the vehicle, drives the maintenance vehicle 1a to the garage 26, and performs the maintenance of the maintenance vehicle 1a at the garage 26.

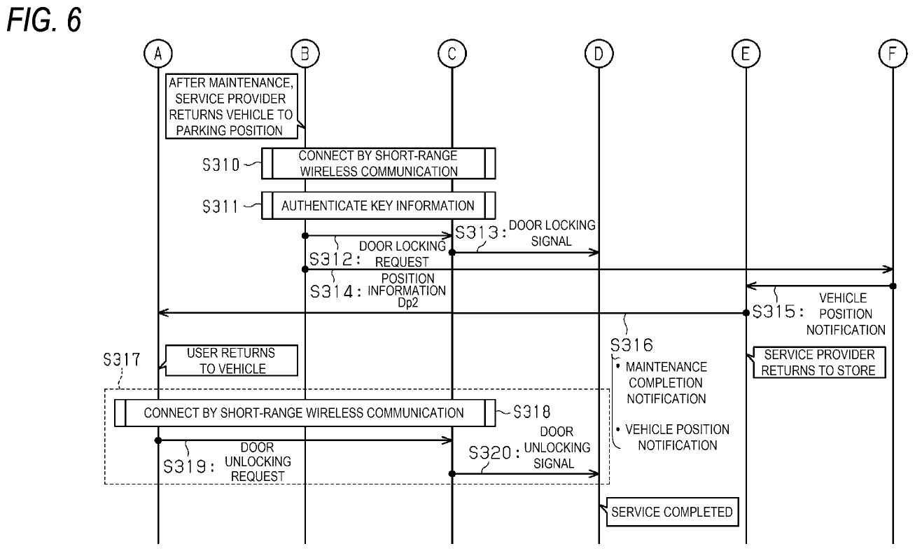

As illustrated in FIG. 6, after the maintenance of the maintenance vehicle 1a is completed, the service provider starts the engine of the maintenance vehicle 1a by the electronic key 2 of the maintenance vehicle 1a and drives the maintenance vehicle 1a to a parking position where the maintenance vehicle 1a is to be returned. A return position of the maintenance vehicle 1a at this time may be a position where the maintenance vehicle 1a is picked up, or may be a position that is separately designated by the user, instead of the position where the maintenance vehicle 1a is picked up.

In step S310, when the service provider 6b is located near the maintenance vehicle 1a so as to lock the maintenance vehicle 1a after parking, the service provider terminal 6b is shifted to a state in which short-range wireless communication is established with the authentication device 9 of the maintenance vehicle 1a.

In step S311, the authentication device 9 and the service provider terminal 6b of the maintenance vehicle 1a execute authentication of the second key information Dk2 registered in the service provider terminal 6b under the state where the short-range wireless communication is established. If the state in which the authentication of the second key information Dk2 executed earlier (in step S307) is established is maintained, the authentication of the second key information Dk2 may be omitted.

In step S312, when a door locking operation is executed on the terminal under the authentication of the second key information Dk2, the service provider terminal 6b transmits a door locking request to the authentication device 9 of the maintenance vehicle 1a through the short-range wireless communication. The door locking operation includes, for example, an operation of touching a door locking button displayed on a screen of the service provider terminal 6b.

In step S313, when receiving the door locking request from the service provider terminal 6b, the authentication device 9 of the maintenance vehicle 1a transmits the door locking signal to the system device 5 of the maintenance vehicle 1a by UHF through the electronic key system 4. When the system device 5 of the maintenance vehicle 1a receives the door locking signal from the authentication device 9 of the maintenance vehicle 1a, the system device 5 locks the vehicle door by using the door locking signal as a trigger. As a result, the vehicle door is locked while the electronic key 2 is left in the maintenance vehicle 1a.

In step S314, when a transmission operation of the position information Dp2 of the maintenance vehicle 1a is executed on the terminal, the service provider terminal 6b transmits the position information Dp2 acquired at this time to the information processing device 8 through the network communication. The acquisition of the position information Dp2 is performed, for example, by a method described with reference to step S401.

In step S315, when the position information Dp2 is received from the service provider terminal 6b, the return position notification unit 32 (information processing device 8) transmits, to the store terminal 27 via the network, a vehicle position notification for notifying a position where the maintenance vehicle 1a is parked on the basis of the position information Dp2. Therefore, the parking position of the maintenance vehicle 1a after the maintenance is completed is managed by the store terminal 27.

In step S316, the store terminal 27 transmits, to the user terminal 6a through the network communication, a maintenance completion notification for notifying that the operation of the maintenance vehicle 1a is completed and a vehicle position notification for notifying the parking position of the maintenance vehicle 1a. By confirming the maintenance completion notification and the vehicle position notification in the user terminal 6a, the user knows that the operation of the maintenance vehicle 1a is completed and the parking position of the maintenance vehicle 1a after the operation is completed.

In step S317, when the user returns to the maintenance vehicle 1a, the authentication device 9 and the user terminal 6a of the maintenance vehicle 1a perform an operation for taking out the original key left in the vehicle, that is, the electronic key 2 from the vehicle. In the future, if there is a revision of regulations that can start the engine of the vehicle 1 with a high-performance mobile phone, the process of step S317 may be omitted.

As a specific operation of step S317, first, in step S318, when the user returns to the maintenance vehicle 1a returned by the user and the user terminal 6a approaches the authentication device 9 of the maintenance vehicle 1a, the authentication device 9 of the maintenance vehicle 1a and the user terminal 6a are shifted to a state in which the short-range wireless communication is established.

In step S319, when the door unlocking operation is executed on the terminal in a state where the short-range wireless communication is established, the user terminal 6a transmits the door unlocking request to the authentication device 9 of the maintenance vehicle 1a through the short-range wireless communication.

In step S320, when receiving the door unlocking request from the user terminal 6a, the authentication device 9 of the maintenance vehicle 1a transmits the door unlocking signal to the system device 5 of the maintenance vehicle 1a by UHF through the electronic key system 4. As a result, the vehicle door is unlocked and the vehicle can be boarded, and the electronic key 2 stored in the vehicle can be taken out. As described above, a series of the on-site car maintenance service is completed.

As described above, in the present embodiment, when the user receives the car maintenance service, the key information Dk (the second key information Dk2 which is different from that given to the user terminal 6a) is delivered to the service provider terminal 6b to be used by the service provider, and the vehicle 1 can also be operated by the service provider terminal 6b. Therefore, since the service provider can start the engine of the vehicle 1 and carry it on the service provider terminal 6b, the user can save the trouble of taking the vehicle 1 to the store or the like. Therefore, it is possible to reduce the annoyance felt by the user at the time of receiving the car maintenance service.

The second key information Dk2 delivered to the service provider terminal 6b is the key information Dk to which restriction on use is given in operating the vehicle 1. Therefore, even when the key information Dk is given to the service provider terminal 6b, the security against unauthorized use of the vehicle 1 can be ensured.

The service provision system 25 is provided with the pick-up position notification unit 30, and when the user receives the on-site car maintenance service, the pick-up position notification unit 30 notifies, from the user, the service provider of the position information Dp1 on a place where the service provider comes to pick up the vehicle 1. Therefore, the user can specify a place where the service provider comes to pick up the vehicle 1, which further contributes to the improvement of convenience when receiving the service.

The service provision system 25 is provided with the return position notification unit 32, and after the car maintenance service is completed, the return position notification unit 32 notifies, from the service provider, the user of the position information Dp2 on a place where the maintenance vehicle 1a is returned to the user. Therefore, the user can specify a place when returning the vehicle 1 to the user after the service is completed, which further contributes to the improvement of convenience when receiving the service.

In the service provision system 25, the operation target 24 is the vehicle 1, and the service is the on-site car maintenance service. Therefore, the user can receive the car maintenance service without having to drive the vehicle 1 and go to the store.

The present embodiment can be modified as follows. The present embodiment and the following modifications can be combined with each other as long as they are technically consistent with each other.

The transmission of the position information Dp1 of the maintenance vehicle 1a and the request for key information issuance may be automatically transmitted, for example, triggered by completion of the vehicle door locking operation using the electronic key 2.

The second key information Dk2 is not limited to being delivered from the information processing device 8 to the service provider terminal 6b via the store terminal 27, and may be delivered directly from the information processing device 8 to the service provider terminal 6b, for example.

In step S501, the confirmation of whether or not the electronic key 2 is left in the vehicle is not limited to the confirmation of whether or not the indoor smart collation is established. For example, for a structure in which the electronic key 2 is stored in a specified position, a sensor, a switch, or the like may be used to detect whether or not the electronic key 2 is in a storage position.

The association of the key information Dk, the user, the service provider, and the like may be managed by the information processing device 8.

The parking position of the vehicle 1 after the vehicle maintenance is completed may be directly notified from the information processing device 8 to the user terminal 6a, for example.

The information processing device 8 may be a server.

The network communication is not limited to 4G, for example, and 5G or the like which is expected to be widespread in the future may be applied. The network communication includes, for example, communication via a relay device such as a wireless LAN.

The key information Dk (first key information Dk1 and second key information Dk2) may be an encrypted data string.

Preferably, the second key information Dk2 given to the service provider terminal 6b is automatically deleted when the reservation time has passed or when the maintenance operation is completed.

The use restriction set in the second key information Dk2 is not limited to a temporal restriction, and may be, for example, an engine start count restriction, a speed restriction, a traveling distance restriction, or the like of the vehicle 1.

The authentication device 9 is not limited to being connected to the electronic key system 4 by wireless communication, and may be connected by wired communication.

The authentication device 9 is not limited to being provided as a device independent of the electronic key system 4 (the system device 5), and may be provided as a device integrated with, for example, the system device 5 (a collation ECU that primarily manages authentication of the electronic key system 4).

The authentication device 9 may be a device capable of performing authentication by wireless communication with the mobile terminal 6 having a key function and capable of operating the vehicle 1 through the electronic key system 4 mounted in a vehicle.

The wireless communication (short-range wireless communication) between the mobile terminal 6 and the authentication device 9 is not limited to Bluetooth, and may be changed to another communication method.

Various frequencies may be used as the frequency of communication between the mobile terminal 6 and the authentication device 9.

The wireless authentication function (authentication system 7) may be a function in which the authentication device 9 mounted on the vehicle 1 and the mobile terminal 6 authenticate (user authenticate) by wireless communication.

The electronic key system 4 is not limited to the smart collation system, and may be any system that performs authentication through wireless communication with the electronic key 2.

The electronic key system 4 may be configured to perform ID collation with the electronic key 2 through, for example, Bluetooth communication.

Various terminals other than the high-performance mobile phone may be applied to the mobile terminal 6. The user terminal 6a and the service provider terminal 6b are not limited to the same terminal, and may have different forms, structures, and the like.

In the second key information Dk2, the information different from the first key information Dk1 is not limited to information including restriction on the use of the vehicle 1, and may be information having at least a part different information from the first key information Dk1.

The specified service is not limited to the car maintenance service, and various services may be applied according to the type of the operation target 24.

The operation target 24 is not limited to the vehicle 1, and may be changed to another target such as a motorcycle or a bicycle.

Next, a technical idea that can be grasped from the embodiment and the modifications will be described.

The service provision system may further include a pick-up position notification unit configured to notify, from the user, the service provider of position information on a place where the service provider comes to pick up the operation target when the user receives the service.

The service provision system may further include a return position notification unit configured to notify, from the service provider, the user of position information on a place where the operation target is to be returned to the user after the service is completed.

In the service provision system, the operation target may be a vehicle, and the service may be a car maintenance service for performing maintenance of the vehicle.

As a part of the description of the present application, the contents of Japanese Patent Application No. 2018-245257 filed Dec. 27, 2018 is incorporated.

1. A service provision system in which an operation of an operation target is allowed when authentication is established via short-range wireless communication between an authentication device connected to the operation target and a mobile terminal having acquired key information required for the authentication, the service provision system comprising:
a first delivery unit configured to deliver first key information as the key information to a mobile terminal carried by a user of the operation target; and
a second delivery unit configured to deliver, when the user receives a service from a service provider that provides the service specified to the operation target, second key information including different information from the first key information as the key information to a mobile terminal carried by the service provider.

2. The service provision system according to claim 1, wherein the second key information includes a restriction on an operation of the operation target as the different information.

3. A service provision method in which an operation of an operation target is allowed when authentication is established via short-range wireless communication between an authentication device connected to the operation target and a mobile terminal having acquired key information, the service provision method comprising:
a step of delivering first key information as the key information to the mobile terminal carried by a user of the operation target; and
a step of delivering, when the user receives a service from a service provider that provides the service specified to the operation target, second key information including different information from the first key information as the key information to a mobile terminal carried by the service provider.
